(19) United States
(12) Patent Application Publication
(10) Pub. No.: US 2007/0057929 A1
(43) Pub. Date: Mar. 15, 2007

(54) Navigation device with a contoured region that provides tactile feedback

(76) Inventor: Tong Xie, San Jose, CA (US)

Correspondence Address: AVAGO TECHNOLOGIES, LTD., P.O. BOX 1920, DENVER, CO, 80201-1920, US

(21) Appl. No.: 11/225,441

(22) Filed: Sep. 13, 2005

(51) Int. Cl. G09G 5/00

(52) U.S. Cl. 345/175

(57) ABSTRACT

A navigation device includes a surface and an optical motion sensor. A user moves a finger across the surface to provide navigation information to a host device for the navigation device. The surface includes a contoured region that provides tactile feedback to the user as the user moves the finger across the surface. The optical motion sensor senses motion of the finger across the surface.

### BACKGROUND

An optical joystick is a navigation device suitable for small electronics such as personal digital assistants (PDAs) cell phones and other mobile and portable electronic devices. An optical joystick typically utilizes a sensor array, a light source and optics to detect motion of a user's finger on a navigation surface. The sensor array captures the reflected light off the navigation surface. A correlation based algorithm is used to determine the relative motion of the finger from the changes in captured light.

In an optical joystick, the navigation surface is typically located on an optically transparent cover piece that protects the navigation engine (sensor and light source) and establishes a physical interface for the user's finger to navigate upon.

Existing optical joystick designs do not offer mechanical feedback to a user as do navigation devices that are implemented with moving parts. For example, a slide pad motion navigation is a mechanical device that allows a user to navigate based on mechanical movement of a pod placed at the center of the slide pad motion navigation device. A spring structure creates a force feedback to the user as the pod is displaced from the center of the slide pad motion navigation device. Such spring force offers the user a sense of the relative position of the pod relative to the center slide pad motion navigation device. An optical joystick, however, has only a flat outer surface for the user finger to navigate on, with no mechanically movable parts to provide feedback on the current position of a user's finger.

### SUMMARY OF THE DISCLOSURE

In accordance with an embodiment of the present invention, a navigation device includes a surface and an optical motion sensor. A user moves a finger across the surface to provide navigation information to a host device for the navigation device. The surface includes a contoured region that provides tactile feedback to the user as the user moves the finger across the surface. The optical motion sensor senses motion of the finger across the surface.

### BRIEF DESCRIPTION OF THE DRAWINGS

FIG. 1 shows an optical joystick with a contoured region in accordance with an embodiment of the present invention.

FIG. 2 shows a simplified block diagram of an optical motion sensor in accordance with an embodiment of the present invention.

FIG. 3 shows a contoured region of an optical joystick in accordance with another embodiment of the present invention.

FIG. 4 shows a contoured region of an optical joystick in accordance with another embodiment of the present invention.

### DESCRIPTION OF THE EMBODIMENT

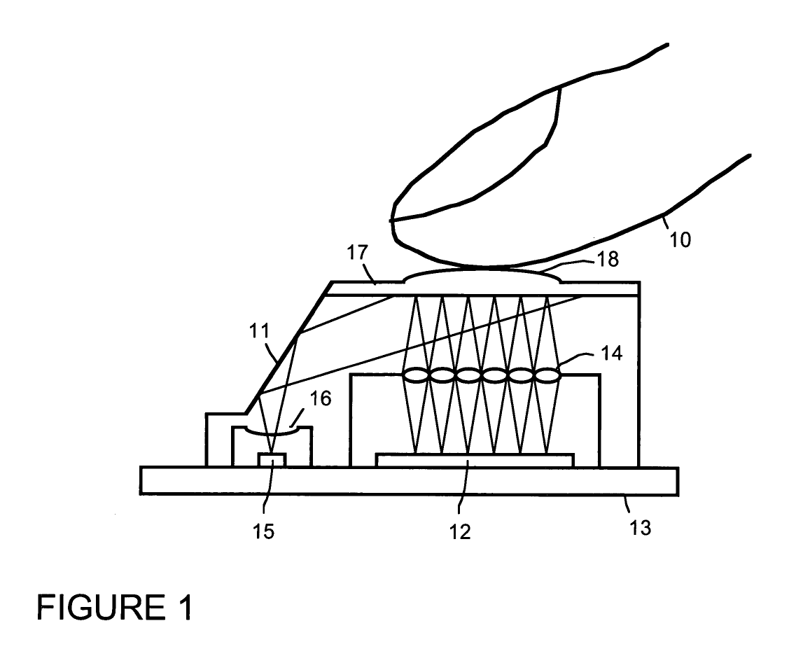

FIG. 1 shows an optical joystick having a light source 15 and a sensor array 12 positioned proximately. Sensor array 12 is mounted on a substrate 13. For example substrate 13 is a printed circuit board (PCB). A lens array 14 is positioned such that the light emitted from the light source 15 and reflected by a wall 11 illuminates a portion of a surface 17. For example, surface 17 may be an integrated part of the housing for the optical joystick or may be implemented as a separate transparent cover piece. For example, surface 17 can be an integrated as part of the optics for the optical joystick.

Surface 17 is at least partially transparent at a wavelength of light emitted by light source 15. For example, when the wavelength of light emitted by light source 15 is not visible to a human eye, surface 17 can be opaque to light visible to a human eye.

Lens array 14 includes M×N elements, where M≧1 and N≧1. Lens array 14 collects light reflected from surface 17 and forms a pattern onto the two-dimensional sensor array 12 underneath. FIG. 1 is meant to be illustrative and is not drawn to scale.

For example, when a light emitting diode (LED) is used as light source 15, lens array 14 may be used to form an image of a surface, for example a finger surface of a user, in contact with surface 17.

An optional lens 16 may be placed between the light source 15 and the surface 20 where the output beam is substantially collimated.

Illumination source 15 may be, for example, a coherent light source such as a laser diode or a vertical cavity surface emitting laser. Alternatively, illumination source 15 may be an incoherent or quasi-coherent light source such as a light emitting diode (LED) or a broadband source with or without an optical filter. Alternative to using illumination source, surface can be illuminated in another way, such as, for example, by an external light source such as ambient light. Lens array 14 is comprised of elements that may be refractive, diffractive or hybrid. Sensor array 12 is, for example, a charge coupled device (CCD) or a complementary metal oxide semiconductor (CMOS) imaging array. Sensor array 12 is preferably positioned to capture the pattern formed by the lens array.

A contoured region 18 on surface 17 creates for the user a natural feel of a center of the optical joystick surface. For example, in FIG. 1, a convex-shape is shown. When moving over the surface of the optical joystick, the finger of a user will experience a feeling of rolling off from the peak as the user's finger moves off center. As further described below, contoured region 18 can have other shapes that provide tactile feedback to the user.

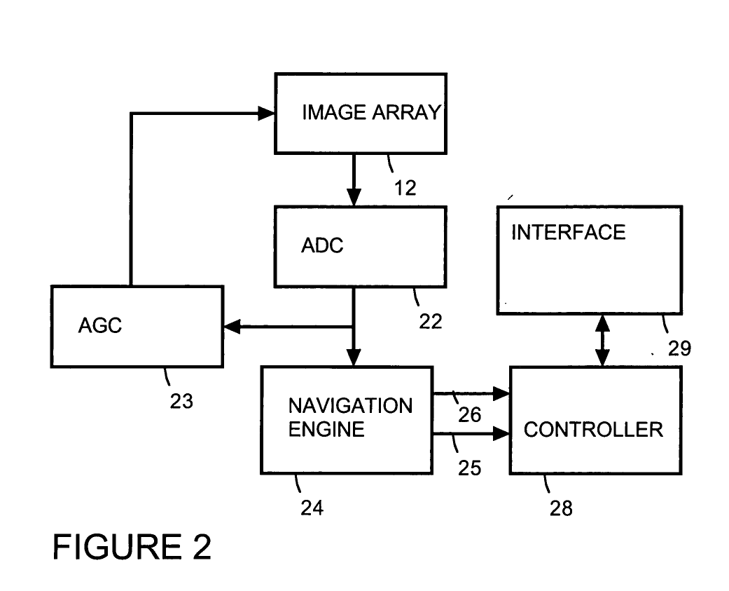

FIG. 2 is a block diagram of an example optical motion sensor used to process information from image array 12. FIG. 2 is illustrative as other optical motion sensor circuitry can be used to process information from image array 12.

An analog-to-digital converter (ADC) 22 receives analog signals from image array 12 and converts the signals to digital data. An automatic gain control (AGC) 23 evaluates digital data received from ADC 22 and controls shutter speed and gain adjust within image array 12. This is done, for example, to prevent saturation or underexposure of images captured by image array 12.

A navigation engine 24 evaluates the digital data from ADC 22 and performs a correlation to calculate overlap of images and to determine shift between images in order to detect motion. For example, the correlation is performed using an image processing algorithm such as a convolution, or can be performed in another way to detect image shift. Navigation engine 24 determines a delta x value placed on an output 25 and determines a delta y value placed on an output 26. A controller 28 receives the delta x value placed on output 25 and the delta y value placed on an output 26. Controller 28, through an interface 29, forwards representatives of these values to a host system. For example, the host system is a PDA, a cell phone or some other device utilizing an optical joystick. The representatives of the delta x values placed on output 25 and the delta y values placed on an output 26 can be transmitted immediately and continuously to the host system, or, alternatively, can be stored for later transmission in response to a query from the host system.

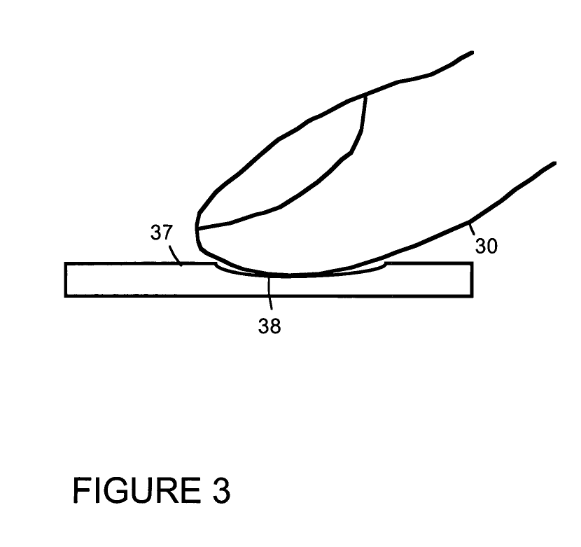

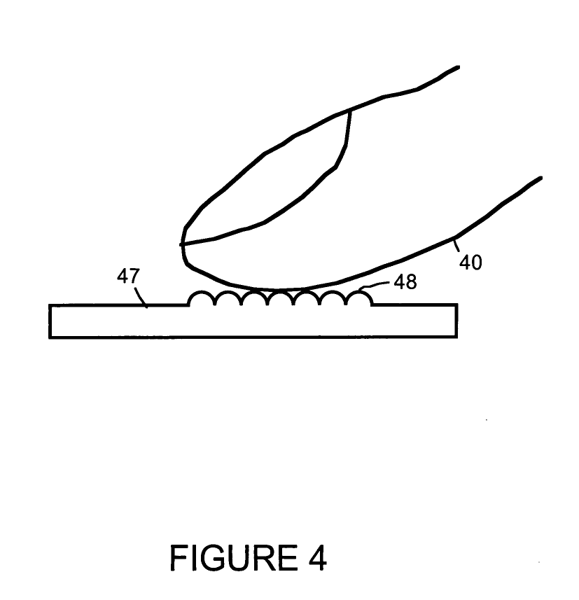

FIG. 3 and FIG. 4 illustrate other contoured shapes that can be used to provide tactile response to a user.

In FIG. 3, a contoured region 38 within a surface 37 has a concave shape. The concave shape provides tactile feedback to a user's finger 30. This allows the user to recognize the position of the user's finger relative to a center of transparent cover concave surface.

In FIG. 4, a contoured region 48 within a surface 47 has a textured shape. The textures provide tactile response to the user as the user navigates a finger across contoured region 48. The texture also can prevent stickiness that can occur when a surface is flat.

While specific examples of contoured regions (convex, concave and textured) have been provided, these are meant to be illustrative of contoured (i.e., non-flat) regions that can be used to provide tactile feedback to a user of an optical joystick.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I Claim:

1. A navigation device comprising:
a surface across which a user moves a finger to provide navigation information to a host device for the navigation device, the surface including a contoured region that provides tactile feedback to the user as the user moves the finger across the surface; and,
an optical motion sensor that senses motion of the finger across the surface.

2. A navigation device as in claim 1 wherein the contoured region is a convex shaped surface region.

3. A navigation device as in claim 1 wherein the contoured region is a concave shaped surface region.

4. A navigation device as in claim 1 wherein the contoured region is textured so as to provide tactile feedback to the finger.

5. A navigation device as in claim 1 wherein the surface is implemented using a transparent cover piece.

6. A navigation device as in claim 1 wherein the surface is integrated as part of housing of the navigation device.

7. A method for obtaining navigation information from a user, the method comprising:
detecting motion of a finger of a user as the finger moves across a surface of a navigation device; and;
providing tactile feedback to the user as the user moves the finger across the surface, the tactile feedback being provided by a contoured region of the surface.

8. A method as in claim 7 wherein the contoured region is a convex shaped surface region.

9. A method as in claim 7 wherein the contoured region is a concave shaped surface region.

10. A method as in claim 7 wherein the contoured region is textured so as to provide tactile feedback to the finger.

11. A method as in claim 7 wherein the surface is implemented using a transparent cover piece.

12. A method as in claim 7 wherein the surface is opaque to light visible to a human eye.

13. A host device comprising:
a navigation device, the navigation device including:
a surface across which a user moves a finger to provide navigation information to the host device, the surface including a contoured region that provides tactile feedback to the user as the user moves the finger across the surface, and
an optical motion sensor that senses motion of the finger across the surface.

14. A host device as in claim 13 wherein the contoured region is a convex shaped surface region.

15. A host device as in claim 13 wherein the contoured region is a concave shaped surface region.

16. A host device as in claim 13 wherein the contoured region is textured so as to provide tactile feedback to the finger.

17. A host device as in claim 13 wherein the host device is a cell phone.

18. A host device as in claim 13 wherein the host device is a personal digital assistant.

19. A host device as in claim 13 wherein the surface is opaque to light visible to a human eye.

20. A host device as in claim 13 wherein the surface is integrated as part of optics for the navigation device.
